(19) United States
(12) Patent Application Publication
(10) Pub. No.: US 2011/0114812 A1
(43) Pub. Date: May 19, 2011

(54) HOLDER FOR A DRINKING GLASS

(75) Inventor: Corstiaan Johannes an Goolen, Delden (NL)

(73) Assignee: VAN GOOLEN, Corstiaan Johannes, AJ Galder (NL)

(21) Appl. No.: 12/997,866

(22) PCT Filed: Jun. 11, 2009
(86) PCT No.: PCT/NL09/50325

§ 371 Date: Feb. 7, 2011

(30) Foreign Application Priority Data
Jun. 11, 2008 (NL) 1035571

(51) Int. Cl. A47G 23/03; B23P 11/00

(52) U.S. Cl. 248/346.03; 29/525

(57) ABSTRACT

Moisture-absorbing holder for a drinking glass, such as a beer glass, which holder comprises a raised annular wall (2) which is made from a plastic material, which wall has clamping elements (3) on the inside for clamping a drinking glass to be placed therein and has retaining elements (4, 5) on the underside for holding a flat circular coaster (6) of a type which is known per se, which closes off the interior space of the holder and forms a support for the drinking glass.

### PRIORITY CLAIM

This application claims priority to the following foreign patent applications:

International Patent Application No. PCT/NL2009/050325, filed Jun. 11, 2009, by Corstiaan Johannes VAN GOOLEN, entitled HOLDER FOR A DRINKING GLASS, IN PARTICULAR A BEER GLASS; and

Netherlands Patent Application No. 1035571, filed Jun. 11, 2008, by Corstiaan Johannes VAN GOOLEN, entitled HOLDER FOR A DRINKING GLASS, IN PARTICULAR A BEER GLASS, each of which is incorporated herein by reference.

### BACKGROUND

The present invention relates to a moisture-absorbing holder for a drinking glass, e.g., a beer glass, for collecting condensation or foam which flows down the exterior of the glass.

Presently, it is often customary in bars and restaurants to provide coasters on the bar and tables, which can absorb moisture. Such coasters can be, e.g., supplied by a brewing company and may display an indication of the respective beer brand or other advertisements. Such coasters have the drawback that they are saturated relatively quickly, and often stick to the glass when this is lifted.

A kind of coaster is known which consists of a circular bottom and has a raised edge along its circumference. Both the bottom and the raised edge are made of moisture-absorbing material. The glass is in this case placed on the bottom and the raised edge clamps around the glass, so that the coaster will remain attached thereto when the glass is being lifted and drunk from. However, these coasters have the drawback that they are more expensive to produce and take up more space.

Developing the abovementioned idea further, it is an object of the present invention to provide a moisture-absorbing holder for a drinking glass, which can be produced in a simple and inexpensive manner, and is effective and pleasant to use.

### SUMMARY OF THE INVENTION

According to the invention, this object is achieved in that the holder comprises an annular raised wall, which is preferably made from a suitable plastic material, which raised wall has one or more clamping elements on the inside for clamping a drinking glass to be placed in the holder and has one or more retaining elements on the underside for holding a flat moisture-absorbing element, in particular a coaster of a known type. The coaster can have the customary circular shape, but any other desired shape is also possible. It is important that the shape of the holder and the shape of the associated coaster are adapted to one another so that the coaster can be held to the holder by the retaining elements.

A raised wall with the respective clamping elements can easily be produced from plastic material and is lightweight. In a preferred embodiment, the holder is therefore made from plastic material. However, other materials, such as tin plate or steel, can also be used.

The outer side of the raised wall may be covered with advertising. A coaster of a kind which is known per se, the diameter of which is adapted to that of the raised wall, can be placed therein and be removed therefrom in a simple manner and be discarded, while the raised wall itself can easily be washed and re-used. Since these holders are attached to the glass, no used and dirty holders are left behind on the bar or on the tables.

Preferably, the outer side of the raised wall of the holder has a tapered part, from the underside where the coaster is held to the upper side where the glass is inserted, for example along the entire height between the underside and the upper side or along a part of this height. This design is such that the holder can be placed on the glass in the reverse position, so that the raised wall partly reaches into the glass and closes off the glass as a kind of lid. The underside of the coaster forming the bottom of the holder is then is directed upwards and could be provided with a message, such as “Gone for a smoke”, or with another message or advertising.

According to another aspect, the invention comprises an assembly of such a holder in combination with at least one moisture-absorbing element, in particular a coaster, in which at least one retaining element of the holder is designed to hold the moisture-absorbing element.

According to yet another aspect of the invention, a method for clamping a drinking glass is provided.

Further advantages, features and details of the invention are explained with reference to the following description.

### BRIEF DESCRIPTION OF THE DRAWINGS

FIG. 1 diagrammatically shows a perspective view of the holder according to the invention.

FIG. 2 shows a diametrical cross section of the holder from FIG. 1.

FIG. 3 shows a half-full drinking glass with a holder which has a different function than in FIGS. 1 and 2.

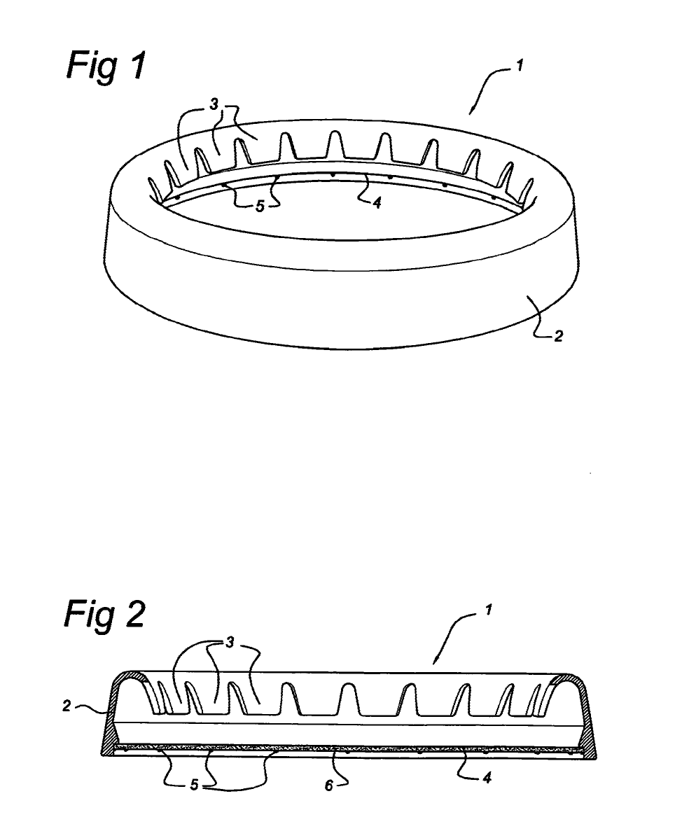

### DETAILED DESCRIPTION OF EMBODIMENTS

As can clearly be seen in the drawing, the holder, which is denoted overall by reference numeral 1, consists of a circular raised wall 2 which, in the illustrated embodiment, tapers from the bottom to the top and at the upper side is bent downwards over a certain distance. The edge which is bent inwards is provided with a number of spaced-apart indentations, so that lips 3 are formed near the upper edge which runs inwards slightly. The wall and the lips which are integrally formed therewith are made from a suitable plastic material, so that the lips form the clamping elements which slightly clamp the glass when a glass is placed in the holder 1.

Near the bottom of the raised wall 2, on the inside, retaining means are provided for a coaster which, in the illustrated embodiment, consists of a circular stop edge 4, with a number of lug-shaped projections 5 being provided at a certain distance below this stop edge 4. A circular coaster 6 of a type which is known per se and with a diameter which is adapted to the holder can easily be pushed over the lug-shaped projections 5 and against the stop edge, so that the coaster is held between said edge 4 and the lugs 5. In order to facilitate pushing the coaster into the holder, the underside of the lug-shaped projections is convex or oblique in order to form a run-up surface for the coaster. The upper side of the lug-shaped projections is flat, so that the coaster is wedged between the stop edge 4 and the flat upper sides of the projections 5. The coaster can be removed from the holder by using some force, in which case it does not matter whether the coaster is damaged or destroyed.

In the position of use, a glass filled with a beverage is inserted from above into the receiving space of the holder defined by the raised wall 2, so that the bottom of the glass rests on the coaster or, if desired, remains just above the coaster. The lips 3 ensure that the glass is connected to the holder 1, so that the holder remains attached to the glass when the latter is raised. In a particular embodiment, the lips 3 are designed to be resilient so that the glass can be placed in the holder in a clamped fit. This ensures that the glass is held in the holder in a stable manner and can be knocked over less easily. In other embodiments, the glass is placed in the holder more loosely and the glass is not held in the holder in a clamped fit.

The condensation or foam which flows down the exterior of the glass ends up on the coaster via indentations present between the lips 3 and is absorbed there. When the glass is empty, the holder can easily be removed from the glass, and the next glass can be placed therein. Furthermore, the coaster can be replaced with another coaster, for example when a coaster has absorbed so much moisture that it has become saturated. The coaster can be removed from the holder by pushing the coaster outwards and subsequently the holder can be washed. Due to the wall of the holders being conical, the latter can easily be stacked, provided that no coasters have been inserted. Furthermore, the outer side of the raised wall may be covered with advertising.

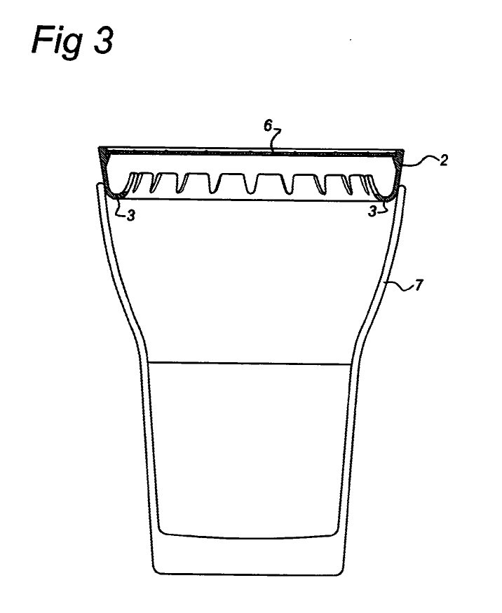

FIG. 3 shows yet another purpose of the holder according to the invention, for which the conical outer wall of the raised wall is essential, since the holder can also be used to close off the glass 7 when it is not completely empty yet. To this end, the holder is placed on the glass upside down, in which case the conical outer side ensures the correct fit with the glass. This prevents undesirable objects from falling into the glass, and is a sign for waiting staff that the glass should not be taken away yet. When used as a closing lid, the underside of the coaster is directed upwards, and advertising or another message may be provided hereon.

An additional advantage of the holder according to the invention is also that the advertising on the holder stands out more, as the holder is clearly visible to bystanders when the glass is being drunk from.

It will be clear that the present invention is not limited to the embodiment illustrated and discussed above, but that a large number of variants and modifications will be obvious to those skilled in the art without departing from the scope of the attached claims. Thus, it is possible to use different clamping elements on the inner side of the raised wall 2 instead of lips 3 or the raised wall may be designed as a double wall. The retaining means for the coaster can also be designed differently.

1. A holder for a drinking glass,
wherein the holder comprises an annular raised wall (2), which raised wall has one or more clamping elements (3) on the inside for clamping a drinking glass to be placed therein and has one or more retaining elements (4, 5) on the underside for holding a flat moisture-absorbing element, in particular a substantially circular coaster (6) of a type which is known per se.

2. The holder as claimed in claim 1, wherein the outer side of the raised wall is of an at least partly tapering design, from the underside where the moisture-absorbing element may be attached, to the upper side, where the drinking glass is inserted.

3. The holder as claimed in claim 1, wherein the raised wall is bent downwards over a certain distance on the upper side, the bent portion being provided with indentations for forming lips (3), which form the clamping elements.

4. The holder as claimed in claim 1, wherein the retaining means are formed by a circular stop edge (4) which is provided near the bottom of the raised wall, on the inside thereof, and against which the peripheral edge of the moisture-absorbing element can rest, with a number of lug-shaped projections (5) being provided at a certain distance below this stop edge, the distance preferably substantially corresponding to the thickness of the moisture-absorbing element.

5. The holder as claimed in claim 4, wherein the lug-shaped projections (5) are provided with a convex or oblique run-up surface on the underside and are flat on the upper side.

6. The holder as claimed in claim 1, which is made from a suitable plastic material.

7. The holder as claimed in claim 1, wherein the annular raised wall surrounds a receiving space, with the shape and dimensions of the receiving space being designed such that the drinking glass is fitted therein in substantially clamped fit.

8. An assembly of a holder as claimed in claim 1, and at least one moisture-absorbing element, in particular a coaster, wherein at least one retaining element of the holder is designed to hold the moisture-absorbing element.

9. The assembly as claimed in claim 8, wherein the holder is initially bottomless and wherein, in the position of use, the bottom of the receiving space of the holder is only formed by the moisture-absorbing element.

10. The assembly as claimed in claim 8, wherein the bottom of the holder is designed to be replaced.

11. A method for holding a drinking glass, the method comprising:
fitting a moisture-absorbing element, in particular a coaster, in a holder as defined in claim 1;
clamping the drinking glass in the holder by pushing the drinking glass between the clamping elements.

12. The holder as claimed in claim 2, wherein the raised wall is bent downwards over a certain distance on the upper side, the bent portion being provided with indentations for forming lips (3), which form the clamping elements.

13. The holder as claimed in claim 2, wherein the retaining means are formed by a circular stop edge (4) which is provided near the bottom of the raised wall, on the inside thereof, and against which the peripheral edge of the moisture-absorbing element can rest, with a number of lug-shaped projections (5) being provided at a certain distance below this stop edge, the distance preferably substantially corresponding to the thickness of the moisture-absorbing element.

14. The holder as claimed in claim 3, wherein the retaining means are formed by a circular stop edge (4) which is provided near the bottom of the raised wall, on the inside thereof, and against which the peripheral edge of the moisture-absorbing element can rest, with a number of lug-shaped projections (5) being provided at a certain distance below this stop edge, the distance preferably substantially corresponding to the thickness of the moisture-absorbing element.

15. The assembly as claimed in claim 9, wherein the bottom of the holder is designed to be replaced.
